(19) United States
(12) Patent Application Publication
(10) Pub. No.: US 2015/0089486 A1
(43) Pub. Date: Mar. 26, 2015

(54) Method of Firmware Upgrade

(71) Applicant: Wistron Corporation, New Taipei City (TW)

(72) Inventor: Chun-Chih Lin, New Taipei City (TW)

(73) Assignee: Wistron Corporation, New Taipei City (TW)

(21) Appl. No.: 14/176,135

(22) Filed: Feb. 9, 2014

(30) Foreign Application Priority Data
Sep. 26, 2013 (TW) 102134804

(51) Int. Cl. G06F 9/445

(52) U.S. Cl. CPC G06F 8/65
USPC 717/168

(57) ABSTRACT

A method of firmware upgrade for an embedded device includes performing a boot procedure to read a boot address, determining whether the boot address is a first address, determining whether a first system image is executable if the boot address is the first address, loading the first system image to enter a first operating system if the first system image is executable, so as to perform a test procedure in the first operating system, and setting the boot address to be a second address after the test procedure is completed.

### BACKGROUND OF THE INVENTION

1. Field of the Invention

The present invention relates to a method of firmware upgrade, and more particularly, to a method of firmware upgrade capable of loading a system image for testing during booting and automatically deleting the system image after the testing.

2. Description of the Prior Art

A functional testing for an electronic device such as an embedded device is required to ensure a functionality of the electronic product before shipping to users. In production lines, an operator may use a first operating system for testing, and then install a second operating system on the electronic device, which is going to be shipped for the market, after the electronic product passes the testing.

Specifically, a test system image is stored or burned in a memory or a storage of the embedded device and thereby the operator turns on the assembled embedded device to enter the operating system for testing. A system image refers to a collection of all programs, system kernel, and data or file status, and the system image is usually stored in a non-volatile memory, such as a flash memory, for being accessed by a central processor of the embedded device.

After the embedded device passes the test, the operator connects the embedded device to the Internet for loading the system image into the embedded device (hereafter called on-line upgrade). As a result, after the embedded device is delivered to a user, the embedded device loads the system image for operating system installment and entering the operating system when the user turns on the embedded device at the first time.

However, there are disadvantages of the on-line upgrade. For example, additional Internet equipment for the on-line upgrade, e.g. servers and internet cables, is required in order to connect the embedded device to the Internet, which increases extra equipment cost as well as routine maintenances for the extra equipment. Besides, procedures such as deleting the system image for testing, downloading and installing the system image for shipping also waste times.

Therefore, there is a need to improve the prior art.

### SUMMARY OF THE INVENTION

It is therefore an objective of the present invention to provide a method of firmware upgrade to improve the above problem.

The present invention discloses a method of firmware upgrade, for an embedded device, comprising performing a boot procedure to read a boot address, determining whether the boot address is a first address, determining whether a first system image is executable if the boot address is the first address, loading the first system image to enter a first operating system if the first system image is executable, so as to perform a test procedure in the first operating system, and setting the boot address to be a second address after the test procedure is completed.

The present invention further discloses a method of firmware upgrade, for an embedded device, comprising performing a boot procedure to read a system image, determining whether the system image is a first system image, and loading the first system image to enter a first operating system if the system image is the first system image, so as to perform a test procedure in the first operating system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional bock diagram of an embedded device according to an embodiment of the present invention.

FIG. 2 is a schematic diagram illustrating data partition of the storage shown in FIG. 1.

FIG. 3 is a schematic diagram of a process of firmware upgrade according to an embodiment of the present invention.

FIG. 4A and FIG. 4B are schematic diagrams illustrating data partition of a storage according to another embodiment of the present invention.

FIG. 5A and FIG. 5B are schematic diagram illustrating data partitions of a storage according to another embodiment of the present invention.

FIG. 6 is a schematic diagram of a process of firmware upgrade 60 according to another embodiment of the present invention.

### DETAILED DESCRIPTION

In earlier times, on-line upgrade for an embedded device is required because of a relative higher price and a relative lower memory capacity of a memory, such that the memory capacity is not enough to contain both of system images for testing and shipping. However, as semi-conductor process progresses, which brings a new memory having a relative lower price and a relative higher memory capacity, and thus containing both of system images for testing and shipping in the same memory becomes feasible. Therefore, a firmware upgrade program is performed by an embedded device of the present invention, which allows the assembled embedded device to automatically load the system image for testing and perform the test procedure in an operating system for testing. After the test procedure is finished, the firmware upgrade program may automatically load the system image for shipping and delete the system image for testing. As a result, the on-line upgrade is no longer necessary for the embedded device, which saves the cost for the Internet equipment and times for downloading the system image for shipping.

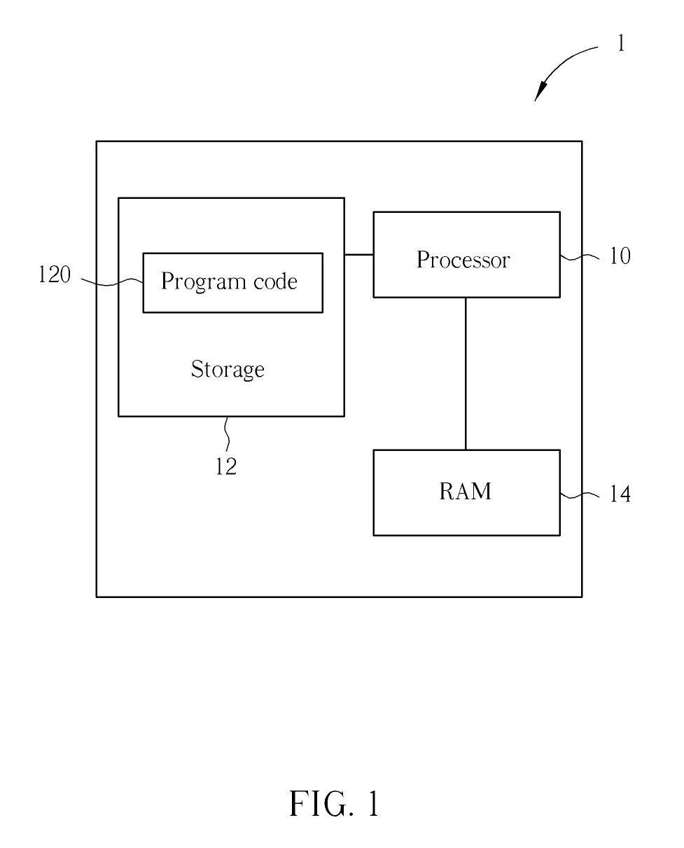

Please refer to FIG. 1, which is a functional bock diagram of an embedded device 1 according to an embodiment of the present invention. The embedded device includes a processor 10, a storage 12 and a random access memory (RAM) 14. The embedded device 1 may be a communication device such as a voice over internet protocol (VoIP) phone or a modem, a household appliance such as a television or a refrigerator and other kind of electronic equipment such as a copier or an ATM. The processor 10 may be a microprocessor or an application-specific integrated circuit (ASIC). The storage 12 is coupled to the processor 10 for storing a program code 120 to be accessed by the processor 10. The storage 12 is preferably a volatile memory, such as but not limited to a flash memory. The RAM 14 is coupled to the processor 10 for temporarily storing data from the storage 12 when the processor 10 is operating.

Before the embedded device 1 is assembled, the operator may perform a data storing procedure to burn the system images for testing and shipping and other required data to the storage 12. For example, the storage 12 may be formatted into a plurality of data partitions, which includes partitions P1, P2, P3 and P4, such that the system images for testing and shipping and other required data manage data may be stored in different partitions.

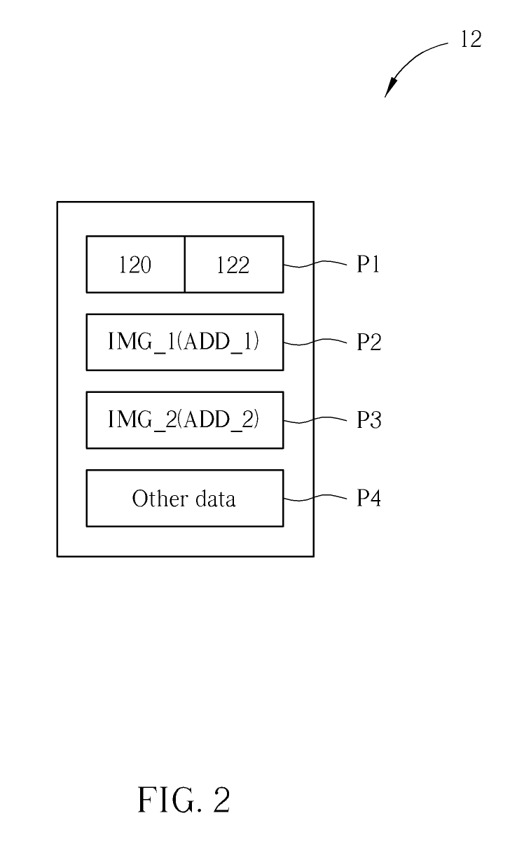

Specifically, please refer to FIG. 2, which is a schematic diagram illustrating data partition of the storage 12. As shown in FIG. 2, the partition P1 is used for storing the program code 120 and a boot loader 122. The partition P2 is used for storing a system image IMG_{—}1 corresponding to an address ADD_{—}1. The partition P3 is used for storing a system image IMG_{—}2 corresponding to an address ADD_{—}2. The partition P4 is used for storing data other than the above system images and programs. The system images IMG_{—}1 and IMG_{—}2 are distinct system images, such as the system images for testing and for shipping, the system images having different versions or for different products. When the processor 10 is going to initialize an operating system, one of the system images IMG_{—}1 and IMG_{—}2 is loaded from the storage 12 into the RAM 14 as a RAM disk, to enter operating systems OS_{—}1 or OS_{—}2 (not shown in FIG. 2). Since the system images IMG_{—}1 and IMG_{—}2 for testing and shipping are burned and contained in the same storage 12, thereby the on-line upgrade for the system image is no longer necessary.

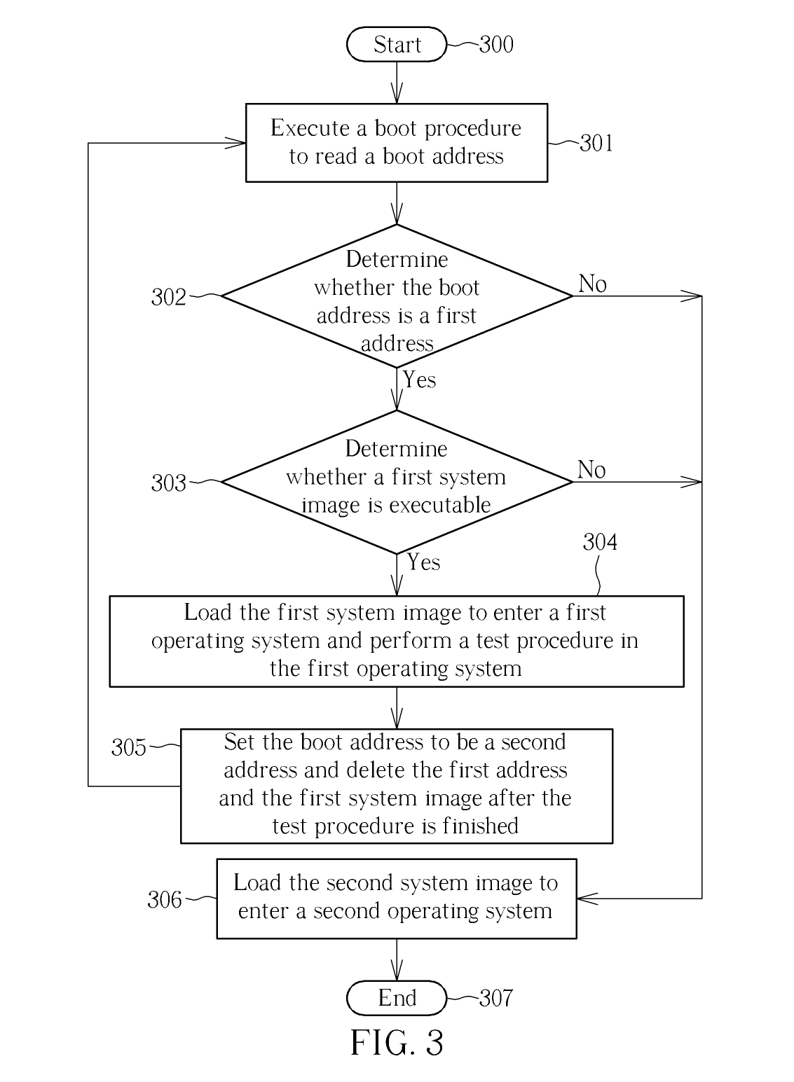

When the system images IMG_{—}1 and IMG_{—}2 and other data are fully stored, the operator turns on the embedded device 1 for testing. Please refer to FIG. 3, which is a schematic diagram of a process 30 of firmware upgrade according to an embodiment of the present invention. The process 30 may be utilized in the embedded device 1 for loading and deleting the system image for testing after a test procedure is finished. The process 30 may be compiled into the program 120 and includes the following steps:

Step 300: Start.

Step 301: Execute a boot procedure to read a boot address.

Step 302: Determine whether the boot address is a first address. Go to Step 303 if yes; go to Step 306 if no.

Step 303: Determine whether a first system image is executable. Go to Step 304 if yes; go to Step 306 if no.

Step 304: Load the first system image to enter a first operating system and perform a test procedure in the first operating system.

Step 305: Set the boot address to be a second address and delete the first address and the first system image after the test procedure is finished. Back to Step 301.

Step 306: Load the second system image to enter a second operating system.

Step 307: End.

In Step 301, once the embedded device 1 is turned on, the processor 10 reads and executes the boot loader 122 and the program code 120 from the partition P1 of the storage 12. The processor 10 executes a boot procedure by the boot loader 122 to read a boot address. The boot address indicates the boot loader 122 where to start reading a memory address of the storage 12, such that the boot loader 122 may load the system image corresponding to the boot address. For example, if the boot address is the address ADD_{—}1, the boot loader 122 loads the system image IMG_{—}1 from the partition P2 of the storage 12; if the boot address is the address ADD_{—}2, the boot loader 122 loads the system image IMG_{—}2 from the partition P3 of the storage 12.

In Step 302 and Step 303, which is assumed that the first address (i.e. ADD_{—}1) corresponds to the system image for testing (i.e. IMG_{—}1), and the second address (i.e. ADD_{—}2) corresponds to the system image for shipping (i.e. IMG_{—}2). Normally, the embedded device 1 performs the test procedure in the operating system OS_{—}1 of the system image IMG_{—}1, the boot address is preferably defaulted by the address ADD_{—}1. If the boot address is the address ADD_{—}1, the boot loader 122 determines whether the system image IMG_{—}1 is executable.

Please note that, in Step 303, the system image IMG_{—}1 may not be executable probably because the system image IMG_{—}1 is damaged or not correctly burned into the storage 12. In such a condition, the boot loader 122 may load the system image IMG_{—}2, such that the test procedure may be performed in the operating system OS_{—}2. In other words, the system image IMG_{—}2 may be regarded as a backup system image, such that the embedded device 1 may perform the test procedure in the operating system OS_{—}2 if the system image IMG_{—}1 is damaged.

In Step 304, if the system image IMG_{—}1 is executable, the boot loader 122 loads the system image IMG_{—}1 in the RAM 14, such that the embedded device 1 enters the operating system OS_{—}1 to perform the test procedure in the operating system OS_{—}1.

In Step 305, the boot address is set to be the address ADD_{—}2 after the test procedure is finished, and the address ADD_{—}1 and the system image IMG_{—}1 are deleted, and the embedded device 1 performs the boot procedure (Step 301) again. In other words, the embedded device 1 is set to load the system image for shipping IMG_{—}2 for the next boot procedure and deletes the address ADD_{—}1 and the system image IMG_{—}1. As a result, the memory capacity of the storage 12 may be released and a situation that the system image IMG_{—}1 for testing is mistakenly loaded after shipping to the user may be avoided by deleting the address ADD_{—}1 and the system image IMG_{—}1.

In Step 306, if the system image IMG_{—}2 is executable, the boot loader 122 loads the system image IMG_{—}2 in the RAM 14 to enter the operating system OS_{—}2 (Step 308).

Therefore, since the system images for testing and shipping in the same storage, by executing the process 30, the embedded device of the present invention is able to load the system image for testing and perform the test procedure in the operating system for testing. After the embedded device passes the test procedure, the process 30 may automatically delete the system image for testing and load the system image for shipping. As a result, the on-line upgrade is unnecessary for the embedded device, which saves the cost for the Internet equipment and the time for on-line upgrade.

In another embodiment of the present invention, if the memory capacity of the storage 12 is not enough for containing both of the system images IMG_{—}1 and IMG_{—}2, the operator may perform a data compression procedure to the system images IMG_{—}1 and IMG_{—}2 to reduce a total size of the system images IMG_{—}1 and IMG_{—}2.

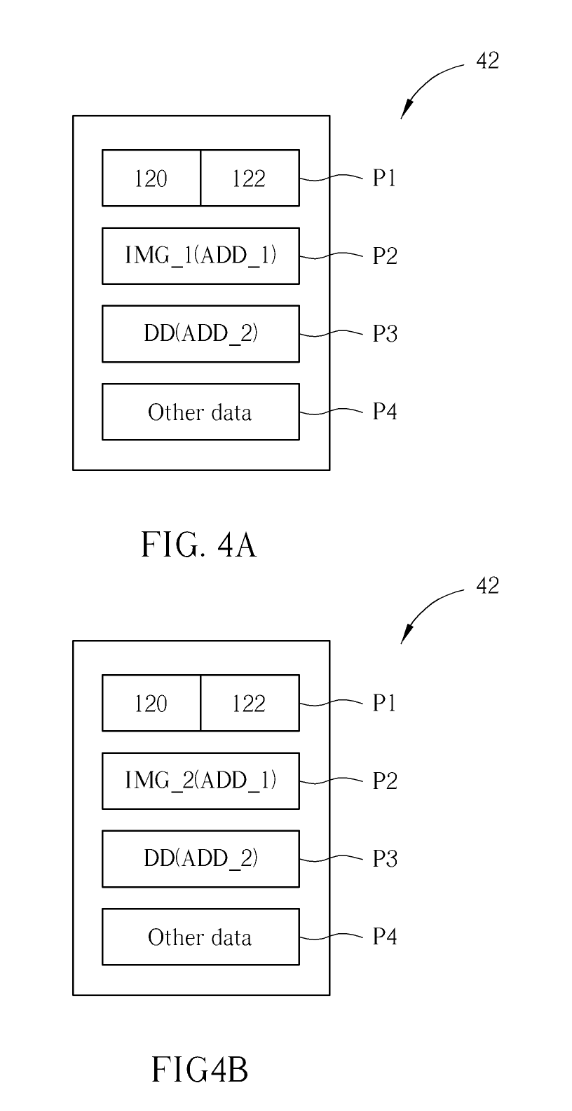

Specifically, please refer to FIG. 4A to FIG. 4B for a first embodiment. FIG. 4A and FIG. 4B are schematic diagrams illustrating data partitions of a storage 42 according to another embodiment of the present invention. The storage 42 may be used in the embedded device 1 and functions the same as the storage 12 shown in FIG. 1. A difference between FIG. 2 and FIG. 4A is that the partition P3 in FIG. 2 stores the system image IMG_{—}2, while the partition P3 in FIG. 4A stores a difference data DD. Normally, the system images IMG_{—}1 and IMG_{—}2 for testing and shipping may have common files, which are exactly the same to be sharable files and such as library files or binary files, and thus the operator may utilize a DIFF algorithm program to compare the system image IMG_{—}1 with the system image IMG_{—}2 to generate the difference data DD. As a result, the partition P3 of the storage 42 may store the difference data DD having a smaller size than the system image IMG_{—}2 having a greater size.

Before the boot loader 122 loads the system image IMG_{—}2, the DIFF algorithm program may perform a reverse operation to recover the system image IMG_{—}2 according to the system image IMG_{—}1 and the difference data DD. Therefore, as shown in FIG. 4B, the recovered system image IMG_{—}2 may replace the system image IMG_{—}1 to be stored in the partition P2 of the storage 42.

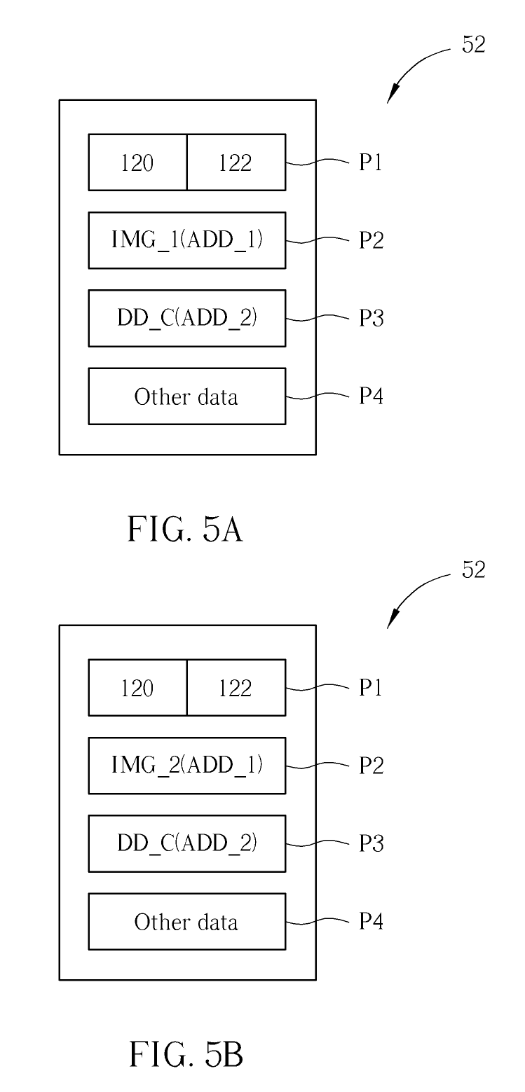

Please refer to FIG. 5A to FIG. 5B for a second embodiment. FIG. 5A and FIG. 5B are schematic diagrams illustrating data partitions of a storage 52 according to another embodiment of the present invention. The storage 52 may be utilized in the embedded device 1 and functions the same as the storage 12 shown in FIG. 1. A difference between FIG. 4A and FIG. 5A is that the partition P3 in FIG. 4A stores the difference data DD, while the partition P3 in FIG. 5A stores a compressed difference data DD_C. If still the difference data DD generated by comparing the system images IMG_{—}1 with IMG_{—}2 is too large to be contained in the storage 52, the operator may utilize a compression program to perform data compression to the difference data DD to generate the compressed difference data DD_C. In such a situation, the partition P3 of the storage 52 may store the compressed difference data DD_C having a smallest size than the system image IMG_{—}2 and the difference data DD having greater sizes.

Before the boot loader 122 loads the system image IMG_{—}2, the compression program may perform a reverse operation to decompress the compressed difference data DD_C to recover the difference data CC. And the DIFF algorithm program may perform the reverse operation to recover the system image IMG_{—}2 according to the system image IMG_{—}1 and the difference data DD. Therefore, as shown in FIG. 5B, the recovered system image IMG_{—}2 replaces the system image IMG_{—}1 to be stored in the partition P2 of the storage 52.

Therefore, in the above mentioned first and second embodiments, the total size of the system images for testing and shipping is reduced by the data compression procedure to be stored in the same storage 42 or 52 if the memory capacity of the storage 42 or 52 is not enough for containing both of the system images for testing and shipping. Before the boot loader 122 loads the system image IMG_{—}2, the system image IMG_{—}2 may be recovered to be read and loaded in the RAM 14. In addition, reducing the total size of the system images for testing and shipping may shorten a time for writing the system images in the storage so as to speed up production.

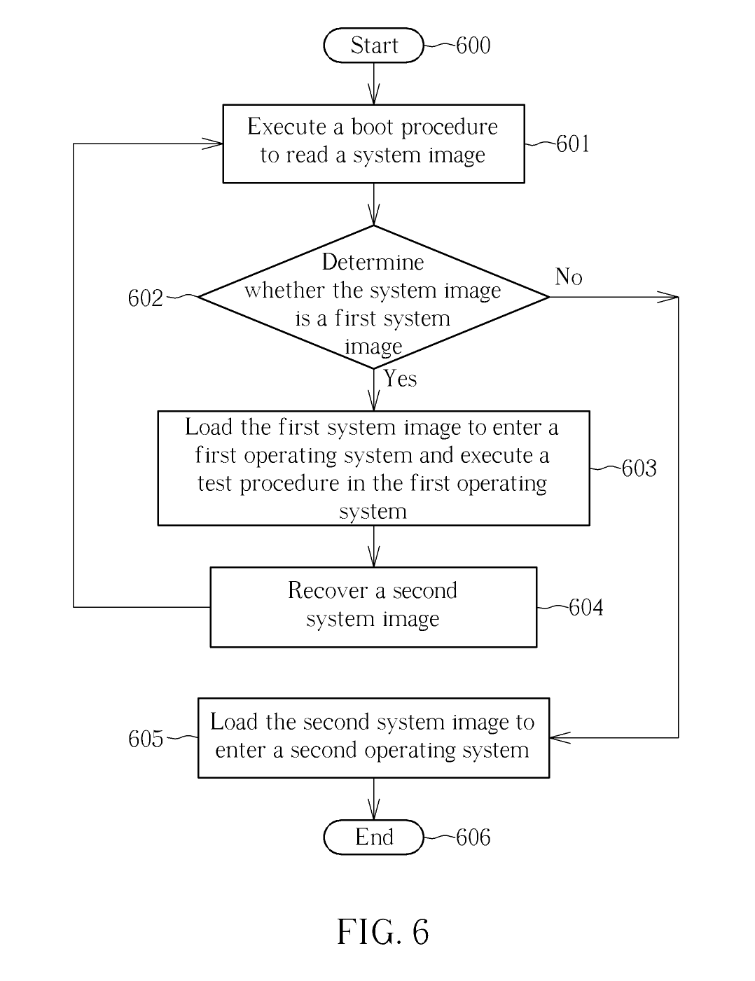

Please refer to FIG. 6, which is a schematic diagram of a process of firmware upgrade 60 according to another embodiment of the present invention. The process 60 may be utilized in the embedded device 1 for loading the system image for testing and recovering the system image for shipping after the test procedure is finished. The process 60 may be compiled into the program code 120 and includes the following steps:

Step 600: Start.

Step 601: Execute a boot procedure to read a system image.

Step 602: Determine whether the system image is a first system image. Go to Step 603 if yes; go to Step 605 if no.

Step 603: Load the first system image to enter a first operating system and execute a test procedure in the first operating system.

Step 604: Recover a second system image. Back to Step 601.

Step 605: Load the second system image to enter a second operating system.

Step 606: End.

From Step 601 to Step 603, the processor 10 executes the boot loader 122 to perform a boot procedure and read a system image. When the boot loader 122 determines the system image is the system image IMG_{—}1 for testing, the boot loader 122 loads the system image IMG_{—}1 from the partition P2 of the storage 42 or 52, such that the processor 10 enters the operating system OS_{—}1 to perform the test procedure in the operating system OS_{—}1.

In Step 604, when the test procedure is finished, the boot loader 122 (or the processor 10) recovers the system image IMG_{—}2 and performs the boot procedure again. When the boot loader 122 reads the system image IMG_{—}2 for shipping, which means that the boot loader 122 determines the system image being read is not the system image IMG_{—}1 (Step 602), the boot loader 122 loads the system image IMG_{—}2 from the partition P2 of the storage 42 or 52 into the RAM 14, to enter the operating system OS_{—}2 (Step 605).

Noticeably, since the storage 42 or 52 stores only one executable system image, the system images IMG_{—}1 and IMG_{—}2 correspond to the same address (e.g. the ADD_{—}1), thereby the boot loader 122 has to read the system images IMG_{—}1 and IMG_{—}2 from the same memory address ADD_{—}1. Therefore, step 302 of the process 30 (determine whether the boot address is a first address) may be unnecessary in the process 60.

In addition, although the process 60 excludes determining whether the system image IMG_{—}1 is executable (i.e. Step 303), the boot loader 122 must determines whether the system image IMG_{—}1 is executable in practical operation. If the system image IMG_{—}1 is not executable, which means common files shared by the system images IMG_{—}1 and IMG_{—}2 are damaged, which results in the recovered system image IMG_{—}2 is not executable. Thus, in order to prevent the recovered system image IMG_{—}2 from not executable, the operator must make sure the system image IMG_{—}1, the difference data DD, the compressed difference data and other data are written and burned in the storage 42 or 52 correctly.

Therefore, in order to reduce the total size of the system images for testing and shipping to be contained in the same storage, by executing the process 60, the embedded device of the present invention is able to load the system image for testing and perform the test procedure in the operating system for testing. After the embedded device passes the test procedure, the embedded device may automatically delete the system image for testing and load the system image for shipping by executing the process 60. As a result, the on-line upgrade is unnecessary for the embedded device, which saves the cost for the Internet equipment and the time for on-line upgrade.

To sum up, the assembled embedded device of the present invention executes the process of firmware upgrade to load the system image for testing during the boot procedure, such that the embedded device is able to load the system image for testing and perform the test procedure in the operating system for testing. After the embedded device passes the test procedure, the process of firmware upgrade may automatically delete the system image for testing and load the system image for shipping. As a result, the on-line upgrade is unnecessary for the embedded device, which saves the cost for the Internet equipment and the time for on-line upgrade.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of firmware upgrade, for an embedded device, comprising:
performing a boot procedure to read a boot address;
determining whether the boot address is a first address;
determining whether a first system image is executable if the boot address is the first address;
loading the first system image to enter a first operating system if the first system image is executable, so as to perform a test procedure in the first operating system; and
setting the boot address to be a second address after the test procedure is completed.

2. The method of claim 1, further comprising:
deleting the first address and the first system image after the testing procedure is finished; and
performing the boot procedure.

3. The method of claim 1, wherein the first system image corresponding to the first boot address, and the second system image corresponding to the second boot address.

4. The method of claim 1, further comprising:
loading a second system image if the first system image is not executable.

5. The method of claim 4, further comprising:
performing the test procedure in the second operating system.

6. The method of claim 4, wherein the second system image is a backup system image.

7. The method of claim 1, wherein the embedded device comprises a storage including a first partition and a second partition.

8. The method of claim 7, wherein the first system image is stored in the first partition of the storage, and a second system image is stored in the second partition of the storage.

9. A method of firmware upgrade, for an embedded device, comprising:
performing a boot procedure to read a system image;
determining whether the system image is a first system image; and
loading the first system image to enter a first operating system if the system image is the first system image, so as to perform a test procedure in the first operating system.

10. The method of claim 9, further comprising:
loading a second system image to enter a second operating system if the system image is not the first system image.

11. The method of claim 9, further comprising:
recovering a second system image after the test procedure is finished.

12. The method of claim 11, wherein recovering the second system image after the test procedure is finished comprises:
recovering the second system image according to the first system image and a difference data by executing a DIFF algorithm program.

13. The method of claim 12, wherein the DIFF algorithm program compares the first system image with the second system image to generate the difference data.

14. The method of claim 12, wherein a storage comprised in the embedded device comprises:
a first partition for storing the first system image or the second system image; and
a second partition for storing the difference data.

15. The method of claim 11, recovering a second system image after the test procedure is finished comprises:
decompressing a compressed difference data by a compression program to generate a difference data; and
recovering the second system image according to the first system image and the difference data by a DIFF algorithm program.

16. The method of claim 15, wherein the compression program performs data compression to the difference data to generate the compressed difference data after the DIFF algorithm program compares the first system image with the second system image.

17. The method of claim 15, wherein the embedded device comprises a storage, and the storage comprises:
a first partition for storing the first system image or the second system image; and
a second partition for storing the compressed difference data.
